(19) United States
(12) Patent Application Publication
(10) Pub. No.: US 2014/0040858 A1
(43) Pub. Date: Feb. 6, 2014

(54) METHOD AND APPARATUS FOR GENERATING RESOURCE EFFICIENT COMPUTER PROGRAM CODE

(71) Applicants: Radu-Marian Ivan, Bucharest (RO); Razvan Ionescu, Bucharest (RO); Ionut-Valentin Vicovan, Bucharest (RO)

(72) Inventors: Radu-Marian Ivan, Bucharest (RO); Razvan Ionescu, Bucharest (RO); Ionut-Valentin Vicovan, Bucharest (RO)

(73) Assignee: FREESCALE SEMICONDUCTOR, INC., Austin, TX (US)

(21) Appl. No.: 14/111,571

(22) PCT Filed: Apr. 20, 2011
(86) PCT No.: PCT/IB11/51732

§ 371 Date: Oct. 14, 2013

(51) Int. Cl. G06F 9/44

(52) U.S. Cl. CPC G06F 8/34
USPC 717/109; 717/106

(57) ABSTRACT

A method for generating resource efficient computer program code is described. The method comprises receiving at an input of an apparatus for creating program code of a representation of source code for computer program code to be generated, analysing by the apparatus by the apparatus the received representation of source code to determine sections within the source code for which potential optimizations are available; and upon determining at least one section within the source code for which at least one potential optimization is available, identifying by the apparatus the at least one potential optimization for the at least one determined section within the source code, and implementing by the apparatus the at least one potential optimization within the source code.

### FIELD OF THE INVENTION

The field of this invention relates to a method and apparatus for generating resource efficient computer program code.

### BACKGROUND OF THE INVENTION

In the field of computers and other programmable machines, the need for efficient applications has lead to compiler optimization of computer program code. Compiler optimization encompasses the process of ‘tuning’ the output of a compiler, e.g. object code, in order to minimize or to maximize some attributes of the executable computer program. The most common requirement is to minimize the time taken to execute a program. However, for some applications, such as applications targeted at running within embedded systems, etc., minimizing the amount of memory occupied by the executable computer program code, and/or the power consumption of, say, a CPU (central processing unit) executing the program code, may additionally/alternatively be a requirement. Compiler optimization typically comprises heuristic methods for improving resource usage, for example reducing the number of processing cycles, memory space, etc., required by the executable computer program. Additionally, such conventional compiler optimizations often utilise information that is gathered by a profiler during testing of previous versions of the executable computer program (referred to as profiler-guided optimization) in order to further optimize the computer program code.

A problem with conventional compiler optimization techniques is that they provide limited visibility and control to the user of the optimizations that are performed. For many applications, and in particular for applications intended for use within embedded real-time systems, where program code size, power consumption and real time execution constraints are all required to be tightly met, programmers typically require close control of optimizations that are made in order to achieve the required balance between the various constraints of the target systems.

Furthermore, conventional compiler optimizations are compiler/profiler specific. Thus, compiler optimizations are typically not consistent across multiple target platforms for which different compilers/profilers are required. In addition, conventional compiler optimizations require full project builds in order to compile the program code. In this manner, in order for a programmer to assess any optimizations made thereby, it is necessary for a full project build to be performed beforehand. As will be appreciated, such full project builds can be time consuming, thereby greatly delaying the assessment of any improvement from performing such optimizations, and thus the development of optimized code.

Further problems that arise out of conventional compiler based optimization techniques include, for example, the optimizations made by the compiler resulting in the subsequent binary code not doing exactly what the programmer intended. Additionally and/or alternatively, optimizations made by the compiler that are intended to optimize the number of executed instructions (which in theory may reduce execution time) detrimentally affect other aspects of the execution such as power consumption, memory requirements, etc.

### SUMMARY OF THE INVENTION

The present invention provides a method for generating resource efficient computer program code, an apparatus for generating computer program code, a non-transitory computer program product and an integrated circuit device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a simplified block diagram of an example of an apparatus for creating computer program code.

FIG. 2 shows a simplified block diagram of an example of a programmable device.

FIG. 3 shows a simplified flowchart of an example of a method for generating resource efficient computer program code.

### DETAILED DESCRIPTION

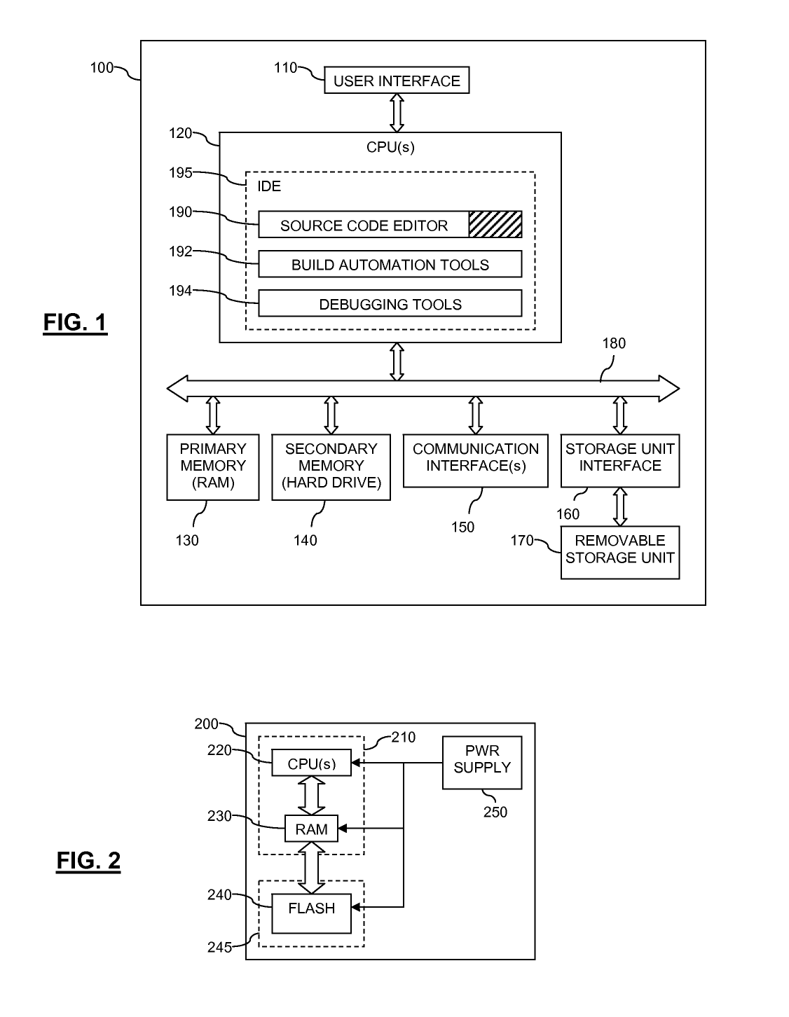

Referring first to FIG. 1, there is illustrated a simplified block diagram of an example of an apparatus 100 for creating computer program code, such as may be implemented by way of one or more personal computers, workstations, etc. The apparatus 100 comprises a user interface 110, for example comprising one or more display devices, one or more input devices, etc. The apparatus 100 further comprises one or more processing units 120, for example one or more CPUs (central processing units), arranged to execute application programs and the like, for example under the control of an operating system (not shown) running on the processing unit(s). The apparatus 100 further comprises primary memory 130, for example in a form of RAM (random access memory), into which may be loaded program code to be executed by the processing unit(s) 120, and data to be accessed during the execution of such program code. The apparatus 100 may further comprise secondary memory 140, for example comprising one or more magnetic disc drives or the like, in which program code to be executed, and data therefor, may be stored, and from which such program code and data may be loaded into the primary memory 130 when required. In addition, the apparatus 100 may comprise one or more communication interfaces 150, for example to enable the apparatus to be connected to a network (not shown), such as a local area network (LAN), wireless area network (WAN), the Internet, etc. The apparatus 100 may also comprise one or more storage unit interfaces 160 to enable access to removable storage devices, illustrated generally at 170, such as removable, e.g. USB (universal serial bus), Flash memory devices, optical memory devices such as CD (compact disc) and/or DVD (digital video/versatile disc) memory devices, etc. Communication between the various components of the apparatus 100 may be provided by way of, say, an address/data bus 180 or the like.

In some examples, the apparatus 100 is adapted for creating computer program code. Accordingly, in the illustrated example, the apparatus 100 is arranged to execute by way of the processing unit(s) 120 one or more application programs for enabling the creation of computer program code. Specifically in the illustrated example, the apparatus 100 is arranged to execute a source code editor application program 190 for enabling the creation of computer program source code. The apparatus 100 may be further arranged to execute additional application programs used within the creation of computer program code. For example, the apparatus 100 may be arranged to execute build automation tools 192 for providing compiler functionality, etc., for converting computer program source code into computer program object code and the like. The apparatus may be further arranged to execute debugging tools 194 for debugging computer program code. The various application programs 190, 192, 194 arranged to enable the creation of computer program code may comprise stand-alone applications, or may comprise parts of an integrated development environment (IDE), as illustrated generally at 195.

Computer program code is created to run on one or more target programmable devices. Such a programmable device may comprise a general purpose device such as a personal computer or a workstation, for example similar to the apparatus 100 illustrated in FIG. 1. Alternatively, a target programmable device on which computer program code is intended to run may comprise a more specialised device, such as an embedded programmable device or the like. FIG. 2 illustrates a simplified block diagram of an example of such a specialised programmable device 200. The programmable device 200 of FIG. 2 comprises one or more integrated circuit devices 210 that comprises one or more processing units 220 and one or more primary memory elements (RAM) 230. The programmable device 200 further comprises secondary memory 240, which for the illustrated example comprises Flash memory. In the illustrated example, the secondary memory 240 is provided on a separate integrated circuit device 245 to the processing units 220 and primary memory 230. However, the secondary memory 240 may be equally provided within the same integrated circuit device 210 as the processing unit(s) 220 and/or the primary memory 230. As is typical for many embedded programmable devices, the embedded programmable device 200 of FIG. 2 comprises a limited power supply 250, for example in a form of one or more batteries.

For such embedded programmable devices such as the one illustrated in FIG. 2, cost constraints often result in such devices comprising limited resources, such as limited processing capabilities and limited memory space (primary and/or secondary), as well as tight power consumption requirements. As a result, significant constraints are often placed on computer program code running within such devices. Even tighter constraints are placed on such computer program code when real-time operations are required to be performed. Accordingly, for many computer program applications, and in particular for applications intended for execution within embedded real-time systems where program code size, power consumption and real time execution constraints are all required to be met, programmers typically require close control of optimizations made to their program code in order to achieve the required balance between the various constraints of the target systems.

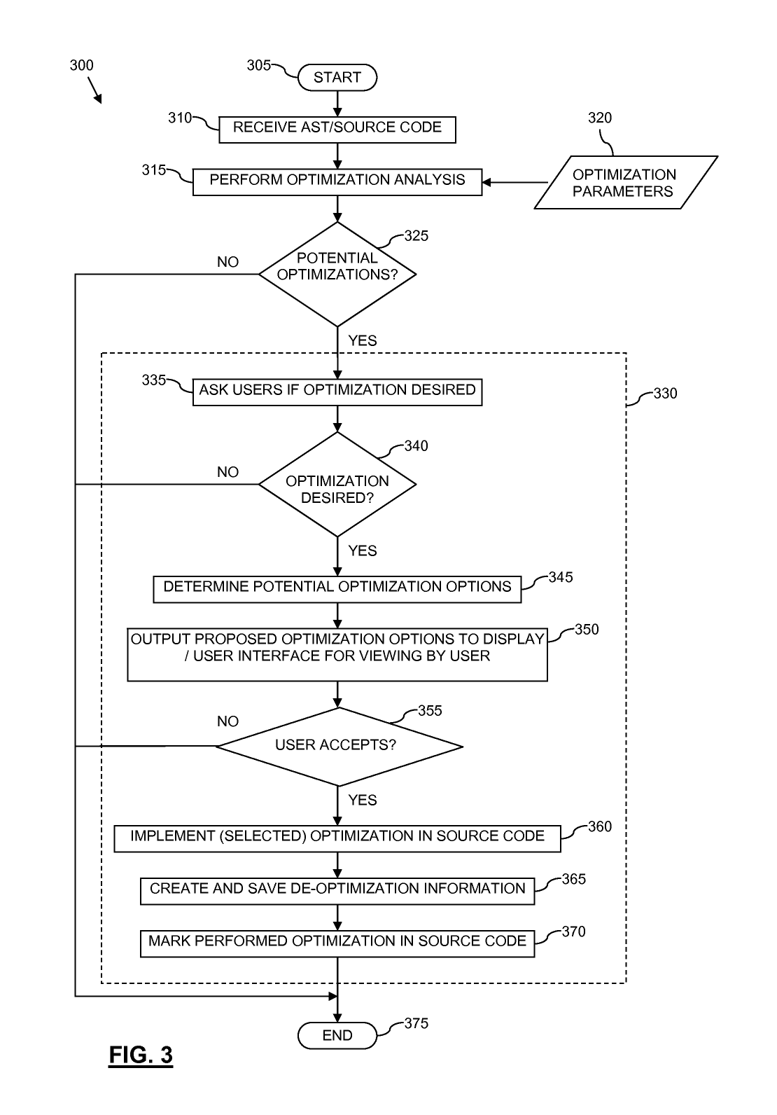

Referring now to FIG. 3, there is illustrated a simplified flowchart 300 of an example of a method for generating resource-efficient computer program code, for example as may be implemented by way of an optimization component within, say, the source code editor 190 of the apparatus 100 of FIG. 1. In summary, the method comprises receiving (at least) a representation of source code for computer program code to be generated, analysing the received representation of the source code to determine sections within the source code for which potential optimizations are available. Upon determining at least one section within the source code for which at least one potential optimization is available, identifying the at least one potential optimization for the at least one identified section within the source code, for example by outputting the at least one potential optimization to a user interface/display for illustrating to a user, and implementing the at least one potential optimization within the source code, for example upon acceptance by a user thereof.

In this manner, a user (programmer) is provided with high visibility and close control of optimizations made to the source code. Furthermore, because optimizations are performed directly on the source code, the optimization may be performed and ‘assessed’ in real-time (i.e. during programming, without the need to wait for a project build).

In greater detail, the method starts at 305, and moves on to 310 with receipt of at least a representation of source code for computer program code to be generated. For example, such a representation may comprise the actual source code itself, or may comprise, say, one or more abstract syntax tree (AST) representations of the source code. Such an AST representation, sometimes simply referred to as a syntax tree, is a representation of the abstract syntactic structure of the source code. The source code, or representation thereof, is then analysed at 315 in order to determine sections within the source code for which potential optimizations may be available. In the illustrated example, such analysis is performed in accordance with one or more predefined optimization parameters. For example, such optimization parameters may comprise one or more resource usage optimization requirements (e.g. program execution time constraints/requirements, program code size constraints/requirements, power consumption constraints/requirements, real-time constraints/requirements, etc.). Additionally and/or alternatively, such resource usage optimization parameters may comprise parameters relating to one or more target platforms, for example relating to one or more specific embedded system platforms or the like. Such resource usage optimization parameters may be user configurable. In this manner, optimization of the source code may be tailored and/or configured by the user in accordance with the specific requirements for a target device on which the computer program code is to be executed.

Having analysed the source code, or a representation thereof, if it is determined that one or more potential optimizations within the source code are available, at 325, the method moves on to 335 where, for the (or each) potential optimization determined to be available within the source code illustrated at 330, a user is asked if optimizations are desired. In this manner, the user is provided with an ability to identify potential optimizations and selectively choose those optimizations that are desired, thereby providing the user with visibility and control over where in the source code optimizations are to be implemented. If the user indicates that a potential optimization is desired at 340, the method moves on to 345, where potential optimization options are determined. For example, different optimization options may be determined for different resource constraints/requirements (e.g. program execution time constraints/requirements, program code size constraints/requirements, power consumption constraints/requirements, real-time constraints/requirements, etc.), for different target platforms, etc. The potential optimization options are then output to a user interface, for example user interface 110 of FIG. 1 that may be in a form of a visual display, for displaying to a user at 350 thereby enabling the user to select which (if any) of the determined options is acceptable. Upon selection, for example by the user of an optimization option at 355, the selected optimization is implemented within the source code at 360 following, say receiving an acceptance signal, say initiated by the user via the user interface.

In the illustrated example, de-optimization information for the implemented optimization is then created and saved at 365. In this manner, optimizations implemented may be undone, thereby allowing the relevant section(s) of the source code to be subsequently reverted back to its/their previous state. Implemented optimizations may be marked within the source code, for example by way of tags within the code, thereby identifying where optimizations have been made, as illustrated at 370. The method then ends at 375. It will, however, be understood that the source code may be converted into object code using known compiling techniques, and that the object code may be run by a programmable apparatus, for example directly on machine executable code or byte code executable through an interpreter.

It is contemplated that any suitable optimization technique may be used in conjunction with the method illustrated in FIG. 3. For example, it is contemplated that one or more of the following optimization techniques may be implemented within the method illustrated in FIG. 3.

### Simplification of Expressions:

Arithmetic expressions which form a program module may be simplified to obtain a new structure with a lower complexity. For example, the expression:

$$e = \frac{{x}^{3} - {x}^{2}}{{x}^{2} - x}$$

may be simplified to:

$$e = \frac{{x}^{2} ( x - 1 )}{x ( x - 1 )}$$

### Substitution of Common Sub-Expressions:

Common sub-expressions may be substituted with pre-evaluated variables to reduce the number of machine cycles. For example, in a case of:

$$e = \frac{x * x + y * y + z * z}{x * x + y * y + z * z - 1}$$

may be replaced with:

$$e = \frac{a}{a - 1} and a = x * x + y * y + z * z$$

### Simplification of Conditional Expressions:

Many programs have at least one complex conditional instruction structure using complex logic to cover a wide range of possibilities. Using decision tables, optimization methodology on such complex conditional instruction structures may enable such complex conditional instruction structures to be simplified and replaced with equilibrated conditional structures. For example, the conditional instruction structure:

```
if (cpuID <= 200)
      fqz = 2 * cpuID / 100;
else
      if (cpuID <= 300)
                fqz = 2.5 * cpuID / 100;
      else
          if (cpuID <= 600)
                    fqz = 3.5 * cpuID / 100;
                else
                    if (cpuID <= 700)
                    fqz = 4 * cpuID / 100;
                    else
                          if (cpuID <= 800)
                                fqz = 7 * cpuID/ 100;
                          else
                                fqz = 10 * cpuID /100;
```

may be simplified and replaced with the equilibrated conditional structure:

```
if (cpuID <= 600)
      if (cpuID <= 300)
            if (cpuID <= 200)
                  fqz = 2 * cpuID / 100;
            else
                  fqz = 2.5 * cpuID / 100;
      else
            fqz = 3.5 * cpuID / 100;
else
      if (cpuID <= 700)
            if (cpuID <= 800)
                  fqz = 7 * cpuID/ 100;
            else
                  fqz = 10 * cpuID /100;
      else
            fqz = 4 * cpuID / 100;
```

### Invariant Removal:

Invariants, which are generated by programming errors or by temporary variables used for data calculation, may be removed from computer program code. For example, in the code sequence:

for(int i=0; i<size; i++){
sum=0;
sum+=vect[i];}
   the line ‘sum=0’ represents such a programming error since the variable ‘sum’ is needlessly set to ‘0’. Similarly, in the code sequence:

int rez=0, z=45, x=24, y=97, temp;
for(int i=0; i<size; i++){
temp=x+y;
rez=z*temp;}
   the line ‘temp=x+y’ may be moved outside of the loop because the variables x and y are not modified in this context.

### Optimization of Loop Sequences:

Improvements in loop structures can have a significant impact on the execution of an application. For example, in a case of loop jamming, where multiple loops are merged into a single loop, it is possible to improve processing volume; processing volume being the number of high level instructions executed (i.e. source code level instructions).

For example, the loop:

for (i=0;i<n;i++)Sx+=x[i]; for(i=0;i<n;i++)Sy+=y[i];

which has a processing volume of 2*(1+3n)=2+6n, may be optimized to:

for (i=0;i<n;i++){Sx+=x[i];Sy+=y[i];}

which has a reduced processing volume of 1+4n.

Another example of potential improvements in loop structures is loop unrolling, where the processing effort for each loop iteration is increased, whilst reducing the number of loops. For example, the loop:

for(int i=0; i<100000; i++)
sum+=v[i];
   may be ‘unrolled’ to:

for(int i=0; i<100000/2; i+=2{
sum+=v[i];
sum+=v[i+1];}

A still further example of potential improvements in loop structures is the removal of unnecessary loops, where simple repetition of the instructions to be looped would be more efficient. For example, the loop:

for (int i=0; i<4; i++)
v[i]=1;
   may be replaced with:

v[0]=1;

v[1]=1;

v[2]=1;

A still further example of potential improvements in loop structures is the sorting, or ordering, of nested (imbricate) loops in order to reduce a number of entries within inner loops, and also the number of exit checks. For example, the loop structure:

```
int requests = 0;
for(int i=0; i<150; i++)
      for(int j=0; j<100; j++)
            for(int k=0; k<50; k++)
                  requests++;
```

may be replaced with:

```
int requests = 0;
for(int k=0; k<50; k++)
      for(int j=0; j<100; j++)
            for(int i=0; i<150; i++)
                  requests++;
```

### Variable Definition:

Since the variable types used directly affects the memory size used by a program, and the processing effort required therefor, optimizing variable definitions can significantly reduce the memory and processing requirements for a program. For example:

for(int vc=0; vc<100; vc++){ . . . }; //1240 cycles(SC 8156)

for(double vc=0; vc<100; vc++){ . . . }; //10593 cycles(SC 8156)

In the above examples, the declaration of the variables as ‘integers’ results in 1240 processing cycles to perform the specific operations. However, the declaration of the variables as ‘doubles’ results in 10593 processing cycles to perform the specific operations. Furthermore, an integer variable may require, say, 32 bits of memory, whilst a comparable double variable would require 64 bits of memory. In addition, an operation performed that uses integer variables is typically faster (e.g. is less processor intensive) than the same operation that is performed using floating point variables that may require emulations, etc.

### Reuse Variables:

Often a variable used, say, within an initial part of a code module may be reused for a different purpose in a subsequent part of the code module, rather than a separate, new variable being declared. Such reuse of variables helps to reduce the memory requirements for the computer program code.

In addition to code optimization, programming errors may also be detected within source code, and potential corrections suggested to a user. For example, errors that may be detected may include, by way of example, use before initialisation, expressions evaluated to zero, unused variables, etc.

Thus, an example of a method for generating resource-efficient computer program code has been described. The method provides flexible and controllable optimization of source code, and providing high levels of visibility of optimization to a user. In this manner, computer program code for applications, and in particular for applications intended for use within, say, embedded real-time systems where program code size, power consumption and real time execution constraints are all required to be tightly met, may be developed with tight control of optimizations made, thereby enabling the required balance between the various constraints of the target systems to be achieved.

Furthermore, since optimizations are made directly to the source code, and without profiler feedback, the optimizations are advantageously not compiler/profiler specific. As such, the optimizations may be consistent across multiple target platforms, even where different compilers/profilers are required. In addition, optimization of the source code may be performed without the need for compiling the code, and without the need for full project builds.

In addition, by enabling potential optimizations to be determined directly on the source code, potential optimization options may be provided to a user substantially immediately, for example upon writing the code. In this manner, the user (programmer) is able to assess any proposed optimization options whilst the program code is fresh in the user's mind.

Thus, by enabling greater visibility, control and flexibility of computer program code to a user in this manner, the resource usage of computer program code generated may be improved, and/or the time/resources required for the generation of such code may be reduced. For example, the computer program code may be optimised to ensure the number of processing cycles required to execute at least a part of the code is within a required threshold, in order to ensure execution of the computer program code within a target device, such as the device 200 of FIG. 2, is performed within required execution speed parameters. Additionally and/or alternatively, the computer program code may be optimised to ensure that a size of the computer program code ‘image’ is within a required limit, for example to enable the code to be stored within a tangible computer program product of limited size, for example the Flash memory 240 of FIG. 2, a removable storage unit 170 of FIG. 1, etc. Additionally and/or alternatively, the computer program code may be optimized to ensure that the amount of memory required during the execution thereof, for example the amount of RAM 230 in FIG. 2, is within a required limit. Additionally and/or alternatively, the computer program code may be optimized to minimize a power consumption of a processing unit that is executing the computer program code.

In this document, the term ‘tangible’ or ‘non-transitory’ computer program product’ may be used generally to refer to tangible media such as, for example, primary memory 130, 230, secondary memory 140, 240, removable storage devices 170, etc. These and other forms of computer-readable media may store one or more instructions for use by a programmable device, to cause the programmable device to perform specified operations. Such instructions, generally referred to as ‘computer program code’ (which may be grouped in a form of computer programs or other groupings), when executed, enable programmable device to perform functions and operations. Note that the code may directly cause the processor to perform specified operations, be compiled to do so, and/or be combined with other software, hardware, and/or firmware elements (e.g., libraries for performing standard functions) to do so.

As will be appreciated by a skilled artisan, code optimization rarely produces “optimal” output in any true sense; rather, code optimization typically comprises one or more heuristic methods for improving resource usage in typical programs. Thus, the use of the term ‘optimization’ herein is to be construed accordingly, in line with the common understanding of the term in the context of computer program code optimization, and is not to be interpreted as referring to the strict sense of producing ‘optimal’ code.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the functionality of the specific applications 190, 192, 194 illustrated in FIG. 1 for the development of computer program code may be distributed over any suitable alternative arrangement of applications, and is not limited to the specific arrangement of a source code editor application 190, build automation tools application 192 and debugging tools application 194.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method for generating resource efficient computer program code, the method comprising:
receiving at an input of an apparatus for creating program code of a representation of source code for computer program code to be generated:
analysing by the apparatus the received representation of source code to determine sections within the source code for which potential optimizations are available; and
upon determining at least one section within the source code for which at least one potential optimization is available:
identifying by the apparatus the at least one potential optimization for the at least one determined section within the source code; and
implementing by the apparatus the at least one potential optimization within the source code.

2. The method of claim 1, further comprising outputting in a for humans perceptible form the at least one potential optimization for the at least one determined section within the source code to a user interface for illustrating to a user of the computer program code.

3. The method of claim 2, wherein implementing the at least one potential optimization comprises implementing the at least one potential optimization within the source code in response to receiving an acceptance signal, for example from a user thereof.

4. The method of claim 1, wherein analysing comprises analysing the received representation of source code in accordance with at least one optimization parameter.

5. The method of claim 1, wherein the at least one optimization parameter is at least one from a group consisting of: a pre-defined optimization parameter or a user configurable optimization parameter.

6. The method of claim 1, wherein the at least one optimization parameter comprises at least one from a group of:
at least one resource usage optimization requirement; and
at least one target platform parameter.

7. The method of claim 1, wherein the method further comprises creating and saving de-optimization for the at least one potential optimization implemented within the source code.

8. The method of claim 1, further comprising converting the source code into object code.

9-12. (canceled)

13. The method of claim 2, wherein analysing comprises analysing the received representation of source code in accordance with at least one optimization parameter.

14. The method of claim 3, wherein analysing comprises analysing the received representation of source code in accordance with at least one optimization parameter.

15. The method of claim 2, wherein the at least one optimization parameter is at least one from a group consisting of: a pre-defined optimization parameter or a user configurable optimization parameter.

16. The method of claim 3, wherein the at least one optimization parameter is at least one from a group consisting of: a pre-defined optimization parameter or a user configurable optimization parameter.

17. The method of claim 4, wherein the at least one optimization parameter is at least one from a group consisting of: a pre-defined optimization parameter or a user configurable optimization parameter.

18. The method of claim 2, wherein the at least one optimization parameter comprises at least one from a group of:
at least one resource usage optimization requirement; and
at least one target platform parameter.

19. The method of claim 3, wherein the at least one optimization parameter comprises at least one from a group of:
at least one resource usage optimization requirement; and
at least one target platform parameter.

20. The method of claim 4, wherein the at least one optimization parameter comprises at least one from a group of:
at least one resource usage optimization requirement; and
at least one target platform parameter.

21. The method of claim 5, wherein the at least one optimization parameter comprises at least one from a group of:
at least one resource usage optimization requirement; and
at least one target platform parameter.

22. The method of claim 2, wherein the method further comprises creating and saving de-optimization for the at least one potential optimization implemented within the source code.

23. The method of claim 4, wherein the method further comprises creating and saving de-optimization for the at least one potential optimization implemented within the source code.

24. The method of claim 5, wherein the method further comprises creating and saving de-optimization for the at least one potential optimization implemented within the source code.
